(19) United States
(12) Patent Application Publication
(10) Pub. No.: US 2020/0327187 A1
(43) Pub. Date: Oct. 15, 2020

(54) Bayesian Inference Regarding Independence in Two-Way Contingency Tables Having Intrinsic Priors

(71) Applicant: International Business Machines Corporation, Armonk, NY (US)

(72) Inventors: Yingda Jiang, Chicago, IL (US); Svetlana Levitan, Chicago, IL (US)

(21) Appl. No.: 16/380,164

(22) Filed: Apr. 10, 2019

(51) Int. Cl. G06F 17/18; G06N 7/00

(52) U.S. Cl. CPC G06F 17/18; G06N 7/005

(57) ABSTRACT

Estimating a Bayes factor is provided. Table dimensions of a contingency table are determined. A statistical model type to apply to the contingency table is determined. Fixed marginal totals are specified for either rows or columns when a Multinomial sampling model is applied. A table total is computed when a Poisson sampling model is applied or fixed marginal totals are computed when the Multinomial sampling model is applied to a two by two contingency table. The table total is compared to a first threshold when the Poisson sampling model is applied or fixed marginal totals are compared to a second threshold when the Multinomial sampling model is applied to a two by two contingency table. An estimation method is selected to apply to the contingency table to compute the Bayes factor based on table dimensions, sampling model applied, and fixed marginal totals of the contingency table.

### BACKGROUND

### 1. Field

The disclosure relates generally to statistics and more specifically to using Bayesian inference to test for independence in a two-way contingency table by using intrinsic priors.

### 2. Description of the Related Art

Statistics is a branch of mathematics dealing with data collection, organization, analysis, interpretation, and presentation. In applying statistics to, for example, a scientific, industrial, or social problem, it is conventional to begin with identifying a statistical population. Populations can be diverse and represent any type of data. Representative sampling of the population assures the validity of drawing conclusions about an underlying population based on an observed sample or subset. A standard statistical procedure involves the estimation of parameters and test of relationship between observed data samples or a data sample and synthetic data drawn based on an assumed statistical model. A hypothesis of interest is proposed for the statistical relationship in terms of the population parameters represented by the data samples, and it is compared as an alternative to an idealized null hypothesis of assumed relationship. In frequentist statistical inference, whether to reject the null hypothesis is done using statistical tests that quantify the sense in which the quantities are hypothetical frequencies of data patterns under a given statistical model.

In statistics, a two-way contingency table is a type of table in a matrix format that displays frequency distribution of variables. Two-way contingency tables are used in, for example, engineering and scientific research, survey research, business intelligence, and the like. Two-way contingency tables provide a basic picture of the interrelation between two variables and can help find underlying associations between them. One issue involving count data is finding dependence between underlying variables contained in two-way contingency tables.

Two-way contingency tables allow users to see at a glance the frequency counts of different variables. The significance of the difference between the frequency counts can be assessed with a variety of statistical tests including, for example, Pearson's chi-squared test, Fisher's exact test, and Barnard's test, provided cell entries in a two-way contingency table represent the count of the categories formulated by the variables. If the frequency counts of sample individuals in different columns vary significantly between rows, or vice versa, then contingency exists between the two variables. In other words, the two variables are not independent. If no contingency exists, then the two variables are independent. Two random variables are statistically independent if realization of one variable does not affect the probability distribution of the other variable.

Bayesian inference is a method of statistical inference in which Bayes' theorem is used to update the probability for a hypothesis as more evidence or information becomes available. In other words, Bayesian inference is an important technique in statistics as alternative to conventional frequentist methods. Bayesian methods postulate a parameter of interest following a certain distribution with a prior probability density, and captures all the information from the observed data by computing the posterior distribution of the parameter.

### SUMMARY

According to one illustrative embodiment, a computer-implemented method for estimating a Bayes factor of a contingency table is provided. Table dimensions of a two-way contingency table are determined. A statistical model type to apply to the two-way contingency table is determined based on a selection by the user of the client device. The sampling model type is selected from a group consisting of a Multinomial sampling model and a Poisson sampling model. Fixed marginal totals of the two-way contingency table are specified for either rows or columns in response to the Multinomial sampling model being applied to the two-way contingency table. A table total is computed in response to the Poisson sampling model being applied or the fixed marginal totals are computed in response to the Multinomial sampling model being applied when the two-way contingency table is two by two. The table total is compared to a first defined threshold level in response to the Poisson sampling model being applied or the fixed marginal totals are compared to a second defined threshold level in response to the Multinomial sampling model being applied when the two-way contingency table is two by two. A Bayes factor estimation method is selected from a plurality of Bayes factor estimation methods to apply to the two-way contingency table based on determined table dimensions of the two-way contingency table, sampling model applied to the two-way contingency table, and specified fixed marginal totals of the two-way contingency table. The selected Bayes factor estimation method is applied to the two-way contingency table to estimate a Bayes factor that statistically infers independence of categorical variables in the two-way contingency table. According to other illustrative embodiments, a computer system and computer program product for estimating a Bayes factor of a contingency table are provided.

### BRIEF DESCRIPTION OF THE DRAWINGS

FIG. 1 is a pictorial representation of a network of data processing systems in which illustrative embodiments may be implemented;

FIG. 2 is a diagram of a data processing system in which illustrative embodiments may be implemented;

FIG. 3 is a diagram illustrating an example of a Bayes factor estimation process in accordance with an illustrative embodiment; and

FIGS. 4A-4B are a flowchart illustrating a process for estimating a Bayes factor corresponding to a two-way contingency table in accordance with an illustrative embodiment.

### DETAILED DESCRIPTION

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

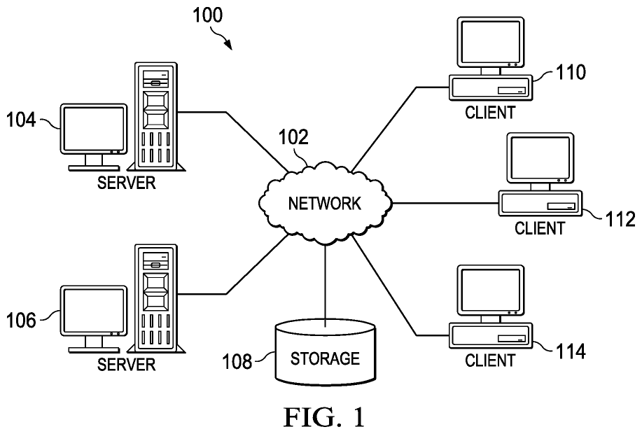

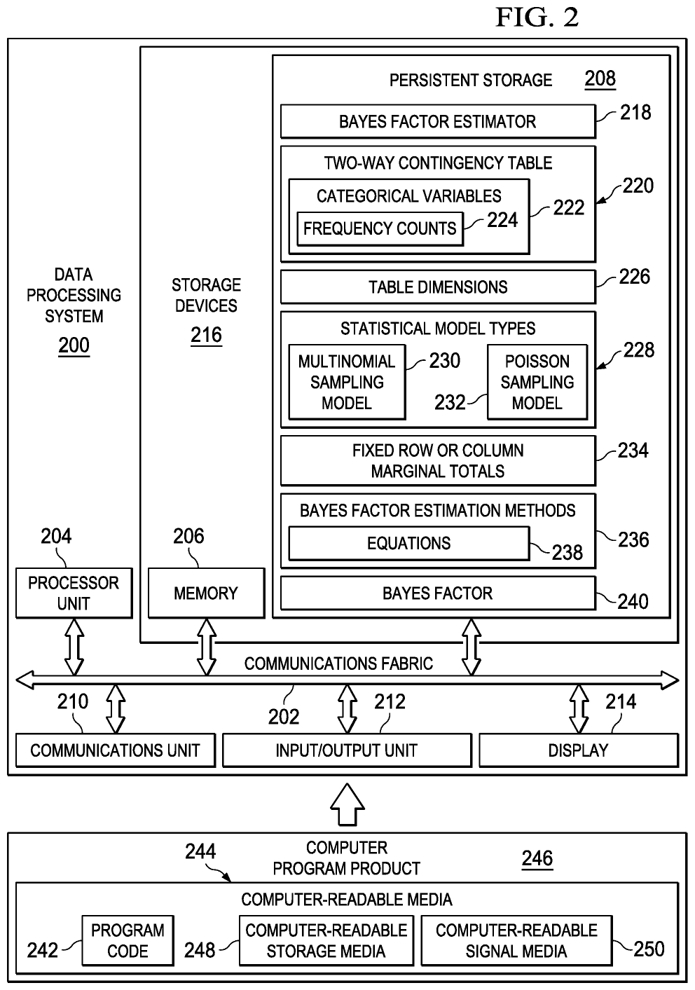

With reference now to the figures, and in particular, with reference to FIG. 1 and FIG. 2, diagrams of data processing environments are provided in which illustrative embodiments may be implemented. It should be appreciated that FIG. 1 and FIG. 2 are only meant as examples and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers, data processing systems, and other devices in which the illustrative embodiments may be implemented. Network data processing system 100 contains network 102, which is the medium used to provide communications links between the computers, data processing systems, and other devices connected together within network data processing system 100. Network 102 may include connections, such as, for example, wire communication links, wireless communication links, and fiber optic cables.

In the depicted example, server 104 and server 106 connect to network 102, along with storage 108. Server 104 and server 106 may be, for example, server computers with high-speed connections to network 102. In addition, server 104 and server 106 provide Bayes factor determination services to registered client device users (e.g., customers). Also, it should be noted that server 104 and server 106 may represent clusters of servers in a data center. Alternatively, server 104 and server 106 may represent computing nodes in a cloud environment that manages Bayes factor determination services.

Bayes factors are used as a Bayesian alternative to classical hypothesis testing based on frequentist methods. Bayes factors can be used as a model selection metric to compare two statistical models under the null and alternative hypothesis. The models under consideration are statistical models. A Bayes factor quantifies support for one statistical model over another statistical model.

Client 110, client 112, and client 114 also connect to network 102. Clients 110, 112, and 114 are clients of server 104 and server 106. In this example, clients 110, 112, and 114 are shown as desktop or personal computers with wire communication links to network 102. However, it should be noted that clients 110, 112, and 114 are examples only and may represent other types of data processing systems, such as, for example, network computers, laptop computers, handheld computers, smart phones, smart televisions, personal digital assistants, and the like. Users of clients 110, 112, and 114 may utilize clients 110, 112, and 114 to access and utilize the Bayes factor determination services provided by server 104 and/or server 106. The client device users utilize the received Bayes factors for statistical inference or further statistical model comparison.

Storage 108 is a network storage device capable of storing any type of data in a structured format or an unstructured format. In addition, storage 108 may represent a plurality of network storage devices. Further, storage 108 may store identifiers and network addresses for a plurality of different servers, identifiers and network addresses for a plurality of different client devices, identifiers for a plurality of different registered users, and the like. Furthermore, storage 108 may store two-way contingency tables, assumed statistical models, sampling methods and their corresponding mathematical expressions, and the like. Storage 108 may also store other types of data, such as authentication or credential data that may include user names, passwords, and biometric data associated with system administrators and registered client device users, for example.

In addition, it should be noted that network data processing system 100 may include any number of additional servers, clients, storage devices, and other devices not shown. Program code located in network data processing system 100 may be stored on a computer readable storage medium and downloaded to a computer or other data processing device for use. For example, program code may be stored on a computer readable storage medium on server 104 and downloaded to client 110 over network 102 for use on client 110.

In the depicted example, network data processing system 100 may be implemented as a number of different types of communication networks, such as, for example, an internet, an intranet, a local area network (LAN), a wide area network (WAN), a telecommunications network, or any combination thereof. FIG. 1 is intended as an example only, and not as an architectural limitation for the different illustrative embodiments.

With reference now to FIG. 2, a diagram of a data processing system is depicted in accordance with an illustrative embodiment. Data processing system 200 is an example of a computer, such as server 104 in FIG. 1, in which computer readable program code or instructions implementing processes of illustrative embodiments may be located. In this example, data processing system 200 includes communications fabric 202, which provides communications between processor unit 204, memory 206, persistent storage 208, communications unit 210, input/output (I/O) unit 212, and display 214.

Processor unit 204 serves to execute instructions for software applications and programs that may be loaded into memory 206. Processor unit 204 may be a set of one or more hardware processor devices or may be a multi-core processor, depending on the particular implementation.

Memory 206 and persistent storage 208 are examples of storage devices 216. A computer readable storage device is any piece of hardware that is capable of storing information, such as, for example, without limitation, data, computer readable program code in functional form, and/or other suitable information either on a transient basis and/or a persistent basis. Further, a computer readable storage device excludes a propagation medium. Memory 206, in these examples, may be, for example, a random-access memory (RAM), or any other suitable volatile or non-volatile storage device. Persistent storage 208 may take various forms, depending on the particular implementation. For example, persistent storage 208 may contain one or more devices. For example, persistent storage 208 may be a hard drive, a flash memory, a rewritable optical disk, a rewritable magnetic tape, or some combination of the above. The media used by persistent storage 208 may be removable. For example, a removable hard drive may be used for persistent storage 208.

In this example, persistent storage 208 stores Bayes factor estimator 218. However, it should be noted that even though Bayes factor estimator 218 is illustrated as residing in persistent storage 208, in an alternative illustrative embodiment Bayes factor estimator 218 may be a separate component of data processing system 200. For example, Bayes factor estimator 218 may be a hardware component coupled to communication fabric 202 or a combination of hardware and software components. In another alternative illustrative embodiment, a first set of components of Bayes factor estimator 218 may be located in data processing system 200 and a second set of components of Bayes factor estimator 218 may be located in a second data processing system, such as, for example, server 106 or client 110 in FIG. 1. In yet another alternative illustrative embodiment, Bayes factor estimator 218 may be located in client devices in addition to, or instead of, data processing system 200.

Bayes factor estimator 218 controls the process of Bayesian inference to determine variable independence in two-way contingency table 220, the estimation of which uses intrinsic priors. Intrinsic priors are preset parameters corresponding to a specific prior data distribution associated with information contained in two-way contingency table 220. Two-way contingency table 220 is a table in a matrix format that records observed counts of categorical variables 222. Categorical variables 222 represent a set of two different categorical variables. It should be noted that each of the two categorical variables in two-way contingency table 220 must contain at least two different categories. A categorical variable represents a particular subject, topic, category, domain, process, or the like that includes a particular set of data. Categorical variables 222 include frequency counts 224. Frequency counts 224 represent a set of two frequency counts that correspond to each category level in categorical variables 222. A frequency count is a number of times an occurrence of, for example, an entry, element, event, unit, value, or the like is observed over a specified period of time for each particular categorical variable. Each frequency count of a category level is recorded in a cell of the matrix forming two-way contingency table 220. Thus, categorical variables 222 may comprise two or more columns and frequency counts 224 may comprise two or more rows, or vice versa, in two-way contingency table 220. In other words, two-way contingency table 220 is a two by two (2×2) or larger (greater than 2×2 higher-dimensional) contingency table. Therefore, two-way contingency table 220 may represent any size contingency table having a dimension greater than or equal to two by two.

Table dimensions 226 represent a size (e.g., total number of columns as one dimension and total number of rows as the other dimension in the matrix) of two-way contingency table 220. Bayes factor estimator 218 determines table dimensions 226 of two-way contingency table 220 based on the number of categories of the two categorical variables.

Statistical model types 228 represent different types of sampling models, such as Multinomial sampling model 230 and Poisson sampling model 232, which Bayes factor estimator 218 applies to two-way contingency table 220. Multinomial sampling model 230 is a sampling model with a fixed marginal total on either a row or column variable. Poisson sampling model 232 assumes that the total sample size is fixed. In other words, data are collected on a predetermined number of individuals or units in a particular population and classified according to levels of a categorical variable of interest. A registered client device user of the Bayes factor determination service provided by data processing system 200 selects which sampling model, either Multinomial sampling model 230 or Poisson sampling model 232, that Bayes factor estimator 218 is to apply to two-way contingency table 220.

Fixed row or column marginal totals 234 determine row or column sums that are fixed or restricted for a corresponding row or column in its respective table margin by the registered user of the Bayes factor determination service. Bayes factor estimator 218 determines marginal totals by summing values in contingency table 220 along rows and columns and records the summed values in the margins of contingency table 220. Bayes factor estimation methods 236 represent a collection of different strategies that Bayes factor estimator 218 applies to different two-way contingency tables based on each respective contingency table's dimensions, statistical model applied, and fixed marginal totals. Bayes factor estimation methods 236 include equations 238. Equations 238 represent a multitude of mathematical expressions for estimating Bayes factor 240. Each particular equation in equations 238 corresponds to a particular Bayes factor estimation method. In other words, in this example, Bayes factor estimator 218 utilizes the equation corresponding to the selected sampling method to determine Bayes factor 240 for two-way contingency table 220. Bayes factor 240 provides support for the evidence in favor of one hypothetical model over the other. It should be noted that Bayes factor estimator 218 may determine Bayes factors for a plurality of different two-way contingency tables at a same time in parallel to increase performance of data processing system 200 by decreasing utilization of resources, such as, for example, processor, memory, storage, bandwidth, and the like.

As a result, data processing system 200 operates as a special purpose computer system in which Bayes factor estimator 218 in data processing system 200 enables Bayesian inference for determining variable independence in two-way contingency table 220 by using intrinsic priors. In particular, Bayes factor estimator 218 transforms data processing system 200 into a special purpose computer system as compared to currently available general computer systems that do not have Bayes factor estimator 218.

Communications unit 210, in this example, provides for communication with other computers, data processing systems, and devices via a network, such as network 102 in FIG. 1. Communications unit 210 may provide communications through the use of both physical and wireless communications links. The physical communications link may utilize, for example, a wire, cable, universal serial bus, or any other physical technology to establish a physical communications link for data processing system 200. The wireless communications link may utilize, for example, shortwave, high frequency, ultra high frequency, microwave, wireless fidelity (Wi-Fi), Bluetooth® technology, global system for mobile communications (GSM), code division multiple access (CDMA), second-generation (2G), third-generation (3G), fourth-generation (4G), 4G Long Term Evolution (LTE), LTE Advanced, fifth-generation (5G), or any other wireless communication technology or standard to establish a wireless communications link for data processing system 200.

Input/output unit 212 allows for the input and output of data with other devices that may be connected to data processing system 200. For example, input/output unit 212 may provide a connection for user input through a keypad, a keyboard, a mouse, a microphone, and/or some other suitable input device. Display 214 provides a mechanism to display information to a user and may include touch screen capabilities to allow the user to make on-screen selections through user interfaces or input data, for example.

Instructions for the operating system, applications, and/or programs may be located in storage devices 216, which are in communication with processor unit 204 through communications fabric 202. In this illustrative example, the instructions are in a functional form on persistent storage 208. These instructions may be loaded into memory 206 for running by processor unit 204. The processes of the different embodiments may be performed by processor unit 204 using computer-implemented instructions, which may be located in a memory, such as memory 206. These program instructions are referred to as program code, computer usable program code, or computer readable program code that may be read and run by a processor in processor unit 204. The program instructions, in the different embodiments, may be embodied on different physical computer readable storage devices, such as memory 206 or persistent storage 208.

Program code 242 is located in a functional form on computer readable media 244 that is selectively removable and may be loaded onto or transferred to data processing system 200 for running by processor unit 204. Program code 242 and computer readable media 244 form computer program product 246. In one example, computer readable media 244 may be computer readable storage media 248 or computer readable signal media 250. Computer readable storage media 248 may include, for example, an optical or magnetic disc that is inserted or placed into a drive or other device that is part of persistent storage 208 for transfer onto a storage device, such as a hard drive, that is part of persistent storage 208. Computer readable storage media 248 also may take the form of a persistent storage, such as a hard drive, a thumb drive, or a flash memory that is connected to data processing system 200. In some instances, computer readable storage media 248 may not be removable from data processing system 200.

Alternatively, program code 242 may be transferred to data processing system 200 using computer readable signal media 250. Computer readable signal media 250 may be, for example, a propagated data signal containing program code 242. For example, computer readable signal media 250 may be an electro-magnetic signal, an optical signal, and/or any other suitable type of signal. These signals may be transmitted over communication links, such as wireless communication links, an optical fiber cable, a coaxial cable, a wire, and/or any other suitable type of communications link. In other words, the communications link and/or the connection may be physical or wireless in the illustrative examples. The computer readable media also may take the form of non-tangible media, such as communication links or wireless transmissions containing the program code.

In some illustrative embodiments, program code 242 may be downloaded over a network to persistent storage 208 from another device or data processing system through computer readable signal media 250 for use within data processing system 200. For instance, program code stored in a computer readable storage media in a data processing system may be downloaded over a network from the data processing system to data processing system 200. The data processing system providing program code 242 may be a server computer, a client computer, or some other device capable of storing and transmitting program code 242.

The different components illustrated for data processing system 200 are not meant to provide architectural limitations to the manner in which different embodiments may be implemented. The different illustrative embodiments may be implemented in a data processing system including components in addition to, or in place of, those illustrated for data processing system 200. Other components shown in FIG. 2 can be varied from the illustrative examples shown. The different embodiments may be implemented using any hardware device or system capable of executing program code. As one example, data processing system 200 may include organic components integrated with inorganic components and/or may be comprised entirely of organic components excluding a human being. For example, a storage device may be comprised of an organic semiconductor.

As another example, a computer readable storage device in data processing system 200 is any hardware apparatus that may store data. Memory 206, persistent storage 208, and computer readable storage media 248 are examples of physical storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

Assessing the association between two variables is a topic broadly discussed in statistics. In view of frequentist ideas, the Pearson's chi-square test and the Fisher's exact test constitute the two main methods used in null hypothesis significance tests. One issue of such tests is that these tests only reject but never truly affirm the null hypothesis that the two variables are independent of each other. However, Bayesian inference provides evidence of accepting the null hypothesis. Actually, it is not uncommon to use Bayesian approaches to test for independence of two variables. A Bayesian approach for two-way contingency tables based on intrinsic priors may provide, for example, reasonable performance in estimating the posterior probability of a null hypothesis when it is favored with palpable evidence and consistency under a large sample size.

From a user's perspective, current tests lack simplicity, completeness, and efficiency. With regard to simplicity, users are expected to generate output for statistical inference by making only a few simple clicks in a user interface or keying in some short commands in a syntax editor window. This calls for a procedure that allows users to run statistical analysis without fully understanding the details or the mechanisms behind the approach.

With regard to completeness, for a two-way contingency table, two popular sampling procedures are used in practice depending on whether the table total or one of the table marginal totals is fixed in an experimental design. The latter may be further divided into two scenarios depending on whether the row marginal total or the column marginal total is fixed. Furthermore, although two by two contingency tables are the most common design and convenient to handle, it is better to meet users' requirements by extending the table design and implementing more general r by s contingency tables (where r and s are integers ≥2).

With regard to efficiency, compared to frequentist methods, Bayesian inference, in general, requires conquering a higher computational hurdle. With the increase of the table total and table dimensions, the computation becomes more and more complicated and increases time cost. Users typically do not want to wait long before obtaining a reasonable and reliable result. However, users do not expect a program to arbitrarily apply some approximations to simplify the computations while paying the price for a significant loss in precision. Moreover, it is also not a well-designed program if the program only analyzes one contingency table within the same procedure. That is, an efficient program provides a pairwise setting of two-way contingency tables constructed by all possible combinations of user-specified factors.

Illustrative embodiments apply different statistical methods, strategies, or equations for Bayesian inference depending on the dimensions of a two-way contingency table, selected statistical model type applied to the table, and specified fixed marginal totals of the table. For two by two contingency tables, illustrative embodiments set a threshold to control the computational complexity corresponding to the tables. For higher-dimensional contingency tables (i.e., larger than two by two contingency tables), illustrative embodiments utilize Monte Carlo method sampling to numerically approximate the Bayes factor for statistical inference. It should be noted that illustrative embodiments execute independent Bayes factor estimation procedures for a plurality of different contingency tables at a same time in parallel to increase computing efficiency.

Illustrative embodiments free users (e.g., customers) from coding from scratch if the users would like to utilize intrinsic priors with preset parameters to make a Bayesian inference regarding independence of variables in two-way contingency tables. Illustrative embodiments are straightforward, convenient, and user-friendly. For example, a user is not expected to understand the mechanism of illustrative embodiments before running the procedure to obtain a Bayesian factor for statistical inference of variable independence. Further, illustrative embodiments are capable of handling high-dimensional contingency tables in a timely manner using either a Poisson sampling model or a Multinomial sampling model.

Illustrative embodiments utilize a plurality of different computing or sampling methods, each particular method having a mathematical expression or equation to determine a Bayes factor corresponding to a particular two-way contingency table. The different computing or sampling methods are featured by the following equations. Illustrative embodiments utilize equation (2), which is shown below, to analyze a two by two contingency table to estimate the Bayes factor under the Poisson sampling model when the total number of frequency count observations is fixed and less than or equal to a first defined threshold level of 500. Illustrative embodiments utilize equation (4), which is shown below, to analyze a two by two contingency table to estimate the Bayes factor under the Poisson sampling model when the total number of frequency count observations is greater than the first defined threshold level of 500.

Illustrative embodiments utilize equations (9) and (12), which are shown below, to analyze a two by two contingency table to estimate an intermediate metric and the Bayes factor under the Multinomial sampling model when the marginal row or column totals are fixed and both are less than or equal to a second defined threshold level of 5000. Illustrative embodiments utilize equations (11) and (12), which are shown below, to analyze a two by two contingency table to estimate the intermediate metric and the Bayes factor under the Multinomial sampling model when the marginal row or column totals are fixed and either or both are greater than the second defined threshold level of 5000.

Illustrative embodiments utilize equation (3), which is shown below, to analyze a contingency table larger than two by two to estimate the Bayes factor under the Poisson sampling model when the total number of frequency count observations is fixed. Illustrative embodiments utilize equations (13) and (14), which are shown below, to analyze a contingency table larger than two by two to estimate the intermediate metric and the Bayes factor under the Multinomial sampling model when the marginal row or column totals are fixed.

Illustrative embodiments utilize the following notations and a different mathematical expression for each particular sampling method in the plurality of sampling methods.
r: r=1, 2, . . . , R denoting the non-empty row index, where R≥2, and R is an integer.
s: s=1, 2, . . . , S denoting the non-empty column index, where S≥2, and S is an integer.
γ**: A matrix (i.e., contingency table) containing all of the observed frequency counts with

$${y}_{**} ≡ ( \begin{matrix}{y}_{11} & {y}_{12} & … & {y}_{1 S} \\ {y}_{21} & {y}_{22} & … & {y}_{2 S} \\ ⋮ & ⋮ & ⋮ & ⋮ \\ {y}_{R 1} & {y}_{R 2} & … & {y}_{RS}\end{matrix} ) , \qquad ( 1 )$$

where γᵣₛ must be a nonnegative integer.
\vec{γ}: \vec{γ}=(γ₁₁, γ₁₂, . . . , γ_{RS})^{T}, a vectorized γ** contingency table containing all of the observed frequency counts.
γᵣₛ: Observed frequency count in a cell on the r-th row and the s-th column of the contingency table. Note that γᵣₛ≥0, and γᵣₛ is an integer.
γᵣ: γᵣ=Σₛ₌₁^{S}γᵣₛ, the marginal total of the r-th row.
γₛ: γₛ=Σᵣ₌₁^{R}γᵣₛ, the marginal total of the s-th column.
Y: Y=Σᵣ₌₁^{R}Σₛ₌₁^{S}γᵣₛ, the total frequency count of the cells.
\hat{γ}ᵣₛ: Expected frequency count in the cell on the r-th row and the s-th column of the contingency table. In other words, \hat{γ}ᵣₛ=γᵣ, γₛ/Y.
γ_{*}: γ_{*}=(γ₁, γ₂, . . . , γ_{S})^{T}, a vector containing marginal column sums, where S≥2.
γ_{*}: γ_{*}=(γ₁, γ₂, . . . , γ_{R})^{T}, a vector containing marginal row sums, where R≥2.
zᵣₛ: The frequency count in the cell on the r-th row and the s-th column for a possible design of a contingency table.
z: z={zᵣₛ}, which denotes the possible design of a contingency table.

For two by two contingency tables when the total number of frequency count observations Y is fixed and Y≤the first defined threshold level of 500, the Bayes factor in favor of the alternative hypothesis is

$${BF}_{10} = \frac{( Y + RS - 1 ) !}{( 2 Y + RS - 1 ) !} {\sum }_{z : \sum {z}_{rs} = Y} ( \begin{matrix}Y \\ z\end{matrix} ) \frac{( {\prod }_{r = 1}^{R} {z}_{r .} ! ) ( {\prod }_{s = 1}^{S} {z}_{. s} ! )}{( {\prod }_{r = 1}^{R} {y}_{r .} ! ) ( {\prod }_{s = 1}^{S} {y}_{. s} ! )} {\prod }_{r = 1}^{R} {\prod }_{s = 1}^{S} \frac{( {z}_{rs} + {y}_{rs} ) !}{{z}_{rs} !} , \qquad ( 2 )$$

where

$$( \begin{matrix}Y \\ z\end{matrix} ) = ( \begin{matrix}Y \\ {z}_{11} , {z}_{12} , {z}_{21} , {z}_{22}\end{matrix} ) = \frac{Y !}{{z}_{11} ! {z}_{12} ! … {z}_{RS} !} . \qquad ( 3 )$$

To decrease the computational cost for two by two contingency tables when the total number of frequency count observations Y is fixed and Y>the first defined threshold level of 500, illustrative embodiments apply

$${BF}_{10} ( t ) = \frac{( t + RS - 1 ) !}{( t + Y + RS - 1 ) !} \frac{Γ ( Y + R ) Γ ( Y + S )}{Γ ( t + R ) Γ ( t + S )} {\sum }_{z : \sum {z}_{rs} = t} ( \begin{matrix}t \\ z\end{matrix} ) \frac{( {\prod }_{r = 1}^{R} {z}_{r .} ! ) ( {\prod }_{s = 1}^{S} {z}_{. s} ! )}{( {\prod }_{r = 1}^{R} {y}_{r .} ! ) ( {\prod }_{s = 1}^{S} {y}_{. s} ! )} {\prod }_{r = 1}^{R} {\prod }_{s = 1}^{S} \frac{( {z}_{rs} + {y}_{rs} ) !}{{z}_{rs} !} \qquad ( 4 )$$

by setting the first defined threshold “t”=500.

For contingency tables with a dimension larger than two by two when the total number of frequency count observations Y is fixed, illustrative embodiments first estimate the cell probabilities by applying

$${θ}_{rs} = \frac{{y}_{rs} + 1}{Y + RS} , \qquad ( 5 )$$

where r=1, 2, . . . , R, s=1, 2, . . . , S, and the cell probabilities are slightly modified to avoid zero entries. Before implementing the sampling method, illustrative embodiments generate a candidate multinomial distribution with cell probabilities equal to Equation (5) by using Algorithm 1, which is shown below.

ALGORITHM 1
RVMultinom Routine: Return a random vector from a multinomial
distribution with specified number of trials and probability parameters

| | |
|---|---|
| 1: | Input Y and θ [symbol] which is estimated by Equation (5). |
| 2: | Set i ← s + (r − 1)S, and re-index θ [symbol] where i = 1,2,..., RS − 1, RS. |
| 3: | Set K ← 30,000 [symbol] number of the random vectors to be [symbol] ulated. |
| 4: | for iteration [symbol] = 1,2,..., K do |
| 5: | Set itemsLeft ← Y. |
| 6: | Set [symbol] mProb ← 0. |
| 7: | for iteration i = 1,2,000, RS − 2, RS − 1 do |
| 8: | Set p ← θ [symbol] /(1 − [symbol] Prob). |
| 9: | Simulate [symbol] ← RV.BINOM( [symbol] temsLeft [symbol] ) [symbol] |
| 10: | Update [symbol] temsLeft ← itemsLeft − [symbol] |
| 11: | Update [symbol] mProb ← [symbol] umProb + [symbol] |
| 12: | end for |
| 13: | Assign [symbol] ← itemsLeft. |
| 14: | Set r ← [symbol] /S [symbol] ← i − (r − 1)S, and re-index [symbol] ← [symbol] |
| 15: | Store the sample [symbol] , where [symbol] Multinomial( [symbol] ). |
| 16: | end for |

[symbol]

indicates data missing or illegible when filed

Illustrative embodiments then estimate the Bayes factor in favor of the alternative hypothesis by calculating the Monte Carlo sampling average by applying

$${BF}_{10} ( t ) = \frac{( Y + RS - 1 ) !}{( 2 Y + RS - 1 ) !} \frac{1}{K} {\prod }_{k = 1}^{K} {\frac{( {\prod }_{r = 1}^{R} {z}_{r .}^{( k )} ! ) ( {\prod }_{s = 1}^{S} {z}_{s .}^{( k )} ! )}{( {\prod }_{r = 1}^{R} {y}_{r .} ! ) ( {\prod }_{s = 1}^{S} {y}_{. s} ! )} [ {\prod }_{r = 1}^{R} {\prod }_{s = 1}^{S} \frac{( {z}_{rs}^{k} + {y}_{rs} ) !}{{z}_{rs}^{k} !} ] [ {\prod }_{r = 1}^{R} {\prod }_{s = 1}^{S} {θ}_{rs}^{{z}_{rs}^{( k )}} ]}^{- 1} , \qquad ( 6 )$$

where θᵣₛ is estimated by Equation (5), and z_{**}^{(k)} is simulated by Algorithm 1, which is shown above.

For two by two contingency tables when the row marginal total is fixed, the default marginal distribution under the null hypothesis is

$${m}_{0} ( {y}_{**} ) = \frac{Γ ( S )}{Γ ( Y + S )} {\prod }_{r = 1}^{R} ( \begin{matrix}{y}_{r .} \\ {y}_{r *}\end{matrix} ) \times {\prod }_{s = 1}^{S} {y}_{. s} ! , \qquad ( 7 )$$

where

$$( \begin{matrix}{y}_{r .} \\ {y}_{r *}\end{matrix} ) = \frac{{y}_{r .} !}{{y}_{r 1} ! {y}_{r 2} ! … {y}_{rS} !} . \qquad ( 8 )$$

The intrinsic marginal distribution is

$${m}_{I} ( {y}_{**} ) = Γ ( S ) {\prod }_{r = 1}^{R} ( \begin{matrix}{y}_{r .} \\ {y}_{r *}\end{matrix} ) \frac{{\prod }_{r = 1}^{R} Γ ( {y}_{r .} + S )}{Γ ( Y + S )} {\sum }_{{( {z}_{1 *} , {z}_{2 *} , … , {z}_{R *} )}_{{\sum }_{θ} {z}_{rs} = {y}_{r .}}} \frac{{\prod }_{s = 1}^{S} {z}_{. s} !}{{\prod }_{r = 1}^{R} {\prod }_{s = 1}^{S} {z}_{ij} !} {\prod }_{r = 1}^{R} ( \begin{matrix}{y}_{r .} \\ {y}_{r *}\end{matrix} ) \frac{{\prod }_{s = 1}^{S} ( {z}_{rs} + {y}_{rs} ) !}{Γ ( 2 {y}_{r .} + S )} , \qquad ( 9 )$$

where

$$( \begin{matrix}{y}_{r .} \\ {y}_{r *}\end{matrix} ) = \frac{{y}_{r .} !}{{z}_{r 1} ! {z}_{r 2} ! … {z}_{rS} !} . \qquad ( 10 )$$

To decrease the computational cost, illustrative embodiments apply

$${m}_{I} ( {y}_{**} ; t ) = Γ ( S ) {\prod }_{r = 1}^{R} ( \begin{matrix}{y}_{r .} \\ {y}_{r *}\end{matrix} ) \frac{{\prod }_{r = 1}^{R} Γ ( {t}_{r .} + S )}{Γ ( t + S )} {\sum }_{{( {z}_{1 *} , {z}_{2 *} , … , {z}_{R *} )}_{{\sum }_{θ} {z}_{rs} = {t}_{r .}}} \frac{{\prod }_{s = 1}^{S} {z}_{. s} !}{{\prod }_{r = 1}^{R} {\prod }_{s = 1}^{S} {z}_{ij} !} {\prod }_{r = 1}^{R} ( \begin{matrix}{t}_{r .} \\ {z}_{r *}\end{matrix} ) \frac{{\prod }_{s = 1}^{S} ( {z}_{rs} + {y}_{rs} ) !}{Γ ( {t}_{r .} + {y}_{r .} + S )} , \qquad ( 11 )$$

where illustrative embodiments set the second defined threshold level “tᵣ”=5000 and consider four different conditions as follows for a particular two by two contingency table design:
1) When y_{1.}≤t_{1.} and y_{2.}≤t_{2.}, use Equation (9);
2) When y_{1.}>t_{1.} and y_{2.}>t_{2.}, use Equation (11) by setting t=t_{1.}+t_{2.};
3) When y_{1.}>t_{1.} and y_{2.}≤t_{2.}, use Equation (11) by setting t=t_{1.}+y_{2.} and t_{2.}=y_{2.}; and
4) When y_{1.}≤t_{1.} and y_{2.}>t_{2.}, use Equation (11) by setting t=y_{1.}+t_{2.} and t_{1.}=y_{1.}. The Bayes factor in favor of the alternative hypothesis is

$${BF}_{10} = \frac{{m}_{I} ( {y}_{**} )}{{m}_{0} ( {y}_{**} )} or {BF}_{10} = \frac{{m}_{I} ( {y}_{**} ; t )}{{m}_{0} ( {y}_{**} )} , \qquad ( 12 )$$

depending on the setting of the second defined threshold level t_{r.}.

For contingency tables with a dimension larger than two by two when the row marginal total is fixed, illustrative embodiments estimate m′₁(γ_{**}) by using

$${m}_{I}^{′} ( {y}_{**} ) = Γ ( S ) {\prod }_{r = 1}^{R} ( \begin{matrix}{y}_{r .} \\ {y}_{r *}\end{matrix} ) \frac{{\prod }_{r = 1}^{R} Γ ( {y}_{r .} + S )}{Γ ( Y + S )} \times \frac{1}{K} {\sum }_{k = 1}^{K} \frac{{\prod }_{s = 1}^{S} {z}_{. s}^{( k )} !}{{\prod }_{r = 1}^{R} {\prod }_{s = 1}^{S} {z}_{ij}^{( k )} !} {\prod }_{r = 1}^{R} ( \begin{matrix}{y}_{r .} \\ {z}_{r *}^{( k )}\end{matrix} ) {\frac{{\prod }_{s = 1}^{S} ( {z}_{rs}^{( k )} + {y}_{rs} ) !}{Γ ( 2 {y}_{r .} + S )} [ ( \begin{matrix}Y \\ {z}^{( k )}\end{matrix} ) {\prod }_{r = 1}^{R} {\prod }_{s = 1}^{S} {θ}_{rs}^{{z}_{rs}^{( k )}} ]}^{- 1} , \qquad ( 13 )$$

where θᵣₛ is estimated by Equation (5) and z_{**}^{(k)} is simulated by Algorithm 1, which is shown above. The Bayes factor in favor of the alternative hypothesis is therefore

$${BF}_{10} = \frac{{m}_{I}^{′} ( {y}_{**} )}{{m}_{0} ( {y}_{**} )} , \qquad ( 14 )$$

where m′_{I}(γ_{**}) is defined by Equation (13).

It should be noted that the estimation procedure is symmetrical in terms of the columns and the rows of the contingency tables. If the column totals are fixed, illustrative embodiments may switch the rows and columns in the contingency table designs and apply different sampling methods above to estimate corresponding Bayes factors.

Thus, illustrative embodiments provide one or more technical solutions that overcome a technical problem of how to decrease computational cost, time cost, and user effort when determining Bayes factors that statistically infer variable independence in higher-dimensional two-way contingency tables. As a result, these one or more technical solutions provide a technical effect and practical application in the field of statistical analysis.

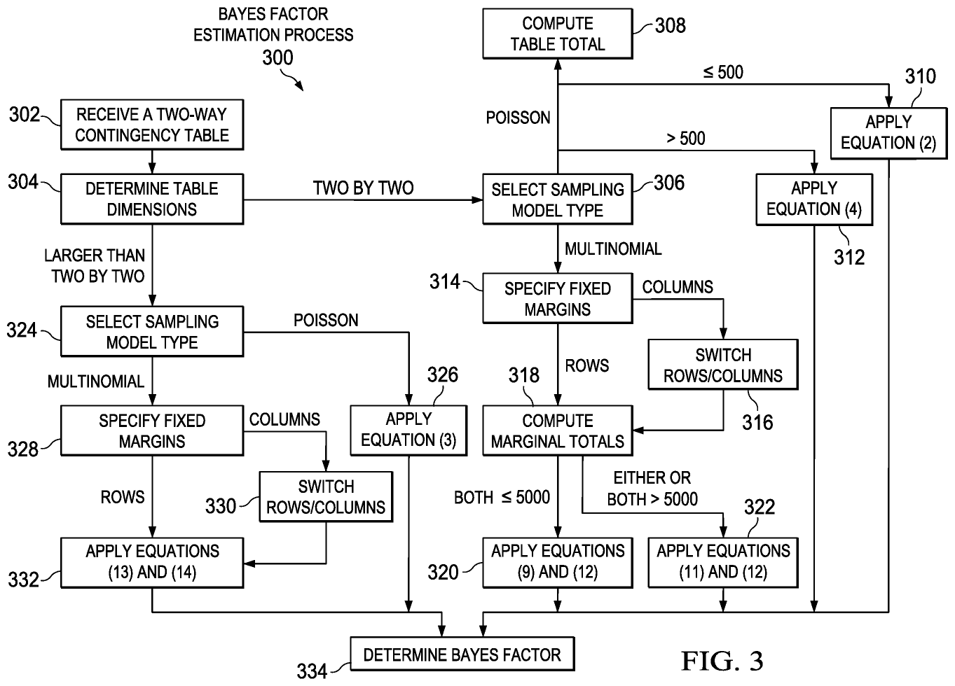

With reference now to FIG. 3, a diagram illustrating an example of a Bayes factor estimation process is depicted in accordance with an illustrative embodiment. Bayes factor estimation process 300 may be implemented in a computer, such as server 104 in FIG. 1 or data processing system 200 in FIG. 2. Bayes factor estimation process 300 specifies a particular Bayes factor estimation method from a plurality of different Bayes factor estimation methods to apply to a particular two-way contingency table to estimate a Bayes factor for that particular two-way contingency table based on determined table dimensions, statistical model applied, and specified fixed marginal totals corresponding to that particular two-way contingency table.

At 302, Bayes factor estimation process 300 receives a two-way contingency table from a client device of a registered user (e.g., customer). At 304, Bayes factor estimation process 300 determines table dimensions, such as two by two or larger, of the two-way contingency table. If Bayes factor estimation process 300 determines that the two-way contingency table is two by two, then Bayes factor estimation process 300 selects a statistical model type, such as Poisson or Multinomial sampling model, to apply to the two-way contingency table based on a selection by the registered user at 306.

If the Poisson sampling model was selected at 306, then Bayes factor estimation process 300 applies the Poisson sampling model to the two-way contingency table and computes a table total for the two-way contingency table at 308. If the computed table total for the two-way contingency table at 308 is less than or equal to a first defined threshold level of 500, then Bayes factor estimation process 300 applies equation (2) of a corresponding estimation method to the two-way contingency table at 310. Alternatively, if the computed table total for the two-way contingency table at 308 is greater than the first defined threshold level of 500, then Bayes factor estimation process 300 applies equation (4) of a corresponding estimation method to the two-way contingency table at 310.

If the Multinomial sampling model was selected at 306, then Bayes factor estimation process 300 applies the Multinomial sampling model to the two-way contingency table and specifies fixed marginal totals for either columns or rows of the two-way contingency table based on selection by the registered user at 314. If columns are specified to be fixed, Bayes factor estimation process 300 switches rows/columns at 316. At 318, Bayes factor estimation process 300 computes the marginal totals for the rows and columns in the two-way contingency table.

If both the computed row marginal totals and the computed column marginal totals of the two-way contingency table at 318 are less than or equal to a second defined threshold level of 5000, then Bayes factor estimation process 300 applies equations (9) and (12) of a corresponding sampling method to the two-way contingency table at 320. If either or both of the computed row marginal totals and the computed column marginal totals of the two-way contingency table at 318 are greater than the second defined threshold level of 5000, then Bayes factor estimation process 300 applies equations (11) and (12) of a corresponding estimation method to the two-way contingency table at 322.

If Bayes factor estimation process 300 determines that the two-way contingency table is larger than two by two (i.e., greater than 2×2, higher-dimensional), then Bayes factor estimation process 300 selects the statistical model type to apply to the two-way contingency table based on a selection by the registered user at 324. If the Poisson sampling model was selected at 324, then Bayes factor estimation process 300 applies the Poisson sampling model to the two-way contingency table. In addition, Bayes factor estimation process 300 applies equation (3) of a corresponding estimation method to the two-way contingency table at 326.

If the Multinomial sampling model was selected at 324, then Bayes factor estimation process 300 applies the Multinomial sampling model to the two-way contingency table and specifies fixed marginal totals for either columns or rows of the two-way contingency table based on a selection by the registered user at 328. If columns are specified to be fixed, Bayes factor estimation process 300 switches rows/columns at 330. At 332, Bayes factor estimation process 300 applies equations (13) and (14) of a corresponding estimation method to the two-way contingency table.

After Bayes factor estimation process 300 applies the appropriate equation or equations to the two-way contingency table, Bayes factor estimation process 300 estimates the Bayes factor for the two-way contingency table. Furthermore, it should be noted that illustrative embodiments may execute Bayes factor estimation process 300 for a plurality of received two-way contingency tables at a same time in parallel to increase computational performance and efficiency.

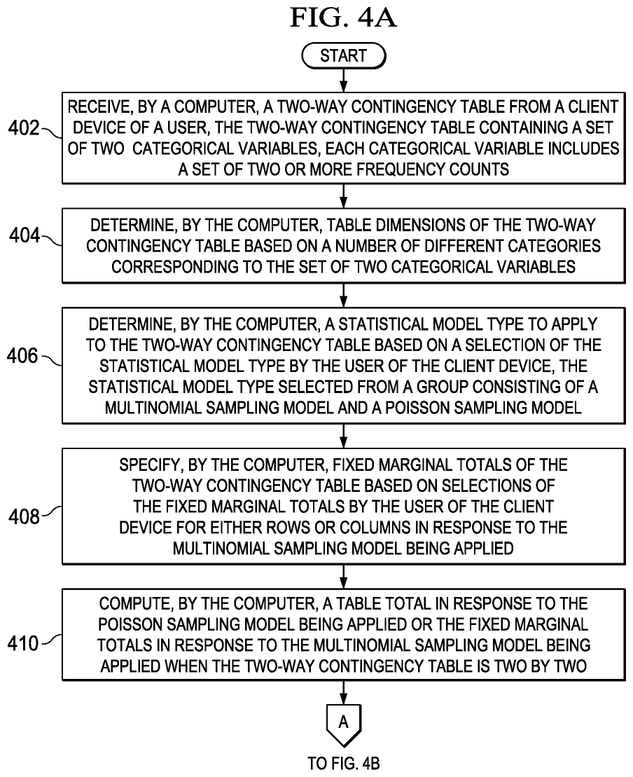

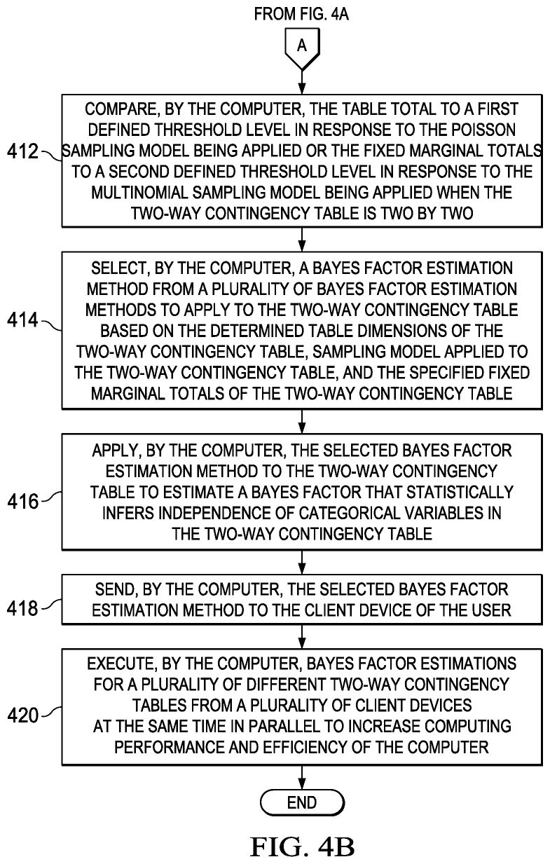

With reference now to FIGS. 4A-4B, a flowchart illustrating a process for estimating a Bayes factor corresponding to a two-way contingency table is shown in accordance with an illustrative embodiment. The process shown in FIGS. 4A-4B may be implemented in a computer, such as, for example, server 104 in FIG. 1 or data processing system 200 in FIG. 2.

The process begins when the computer receives a two-way contingency table from a client device of a user (step 402). The two-way contingency table contains a set of two categorical variables and each categorical variable in the set includes a set of two or more frequency counts. The computer determines table dimensions of the two-way contingency table based on the number of different categories corresponding to the set of two categorical variables (step 404).

Further, the computer determines a statistical model type to apply to the two-way contingency table (step 406). The computer determines the statistical model type to apply to the two-way contingency table based on a selection of the statistical model type by the user of the client device. The statistical model type is selected from a group consisting of a Multinomial sampling model and a Poisson sampling model. In addition, the computer specifies fixed marginal totals of the two-way contingency table (step 408). The computer specifies the fixed marginal totals of the two-way contingency table based on selections of the fixed marginal totals by the user of the client device for either rows or columns under the Multinomial sampling model.

For example, if the user selects the Poisson sampling model, then the total sample size of the two-way contingency table is automatically fixed. This is because the Poisson sampling model assumes a fixed total sample size. If the user selects the Multinomial sampling model, then the user needs to fix either the table row sums or the table column sums to continue the Bayes factor estimation process.

The computer computes a table total in response to the Poisson sampling model being applied or the fixed marginal totals in response to the Multinomial sampling model being applied when the two-way contingency table is two by two (step 410). The computer compares the table total to a first defined threshold level in response to the Poisson sampling model being applied or the fixed marginal totals to a second defined threshold level in response to the Multinomial sampling model being applied when the two-way contingency table is two by two (step 412).

Moreover, the computer selects a Bayes factor estimation method from a plurality of Bayes factor estimation methods to apply to the two-way contingency table based on the determined table dimensions of the two-way contingency table, sampling model applied to the two-way contingency table, and the specified fixed marginal totals of the two-way contingency table (step 414). The computer applies the selected Bayes factor estimation method to the two-way contingency table to estimate a Bayes factor that statistically infers independence of categorical variables in the two-way contingency table (step 416). The computer sends the selected Bayes factor estimation method to the client device of the user (step 418).

Furthermore, the computer executes Bayes factor estimations for a plurality of different two-way contingency tables from a plurality of client devices at a same time in parallel to increase computing performance and efficiency of the computer (step 420). Thereafter, the process terminates.

Thus, illustrative embodiments of the present invention provide a computer-implemented method, computer system, and computer program product for using Bayesian inference to determine independence in a two-way contingency table by using intrinsic priors. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
determining table dimensions of a two-way contingency table;
determining a statistical model type to apply to the two-way contingency table, wherein the statistical model type is selected from a group consisting of a Multinomial sampling model and a Poisson sampling model;
specifying fixed marginal totals of the two-way contingency table for either rows or columns in response to the Multinomial sampling model being applied to the two-way contingency table;
computing a table total in response to the Poisson sampling model being applied or the fixed marginal totals in response to the Multinomial sampling model being applied when the two-way contingency table is two by two;
comparing the table total to a first defined threshold level in response to the Poisson sampling model being applied or the fixed marginal totals to a second defined threshold level in response to the Multinomial sampling model being applied when the two-way contingency table is two by two;
selecting a Bayes factor estimation method from a plurality of Bayes factor estimation methods to apply to the two-way contingency table based on determined table dimensions of the two-way contingency table, sampling model applied to the two-way contingency table, and specified fixed marginal totals of the two-way contingency table; and
applying the selected Bayes factor estimation method to the two-way contingency table to estimate a Bayes factor that statistically infers independence of categorical variables in the two-way contingency table.

2. The method of claim 1 further comprising:
receiving the two-way contingency table from a client device of a user, the two-way contingency table containing a set of two categorical variables and each categorical variable in the set of two categorical variables includes a set of two or more frequency counts, wherein the table dimensions of the two-way contingency table are determined based on a number of categories corresponding to the set of two categorical variables.

3. The method of claim 2 further comprising:
sending the Bayes factor estimation method to the client device of the user.

4. The method of claim 1 further comprising:
executing B ayes factor estimations for a plurality of different two-way contingency tables from a plurality of client devices at a same time in parallel to increase computing performance.

5. The method of claim 1, wherein the Bayesian inference uses intrinsic priors that are preset parameters corresponding to a specific prior data distribution associated with information contained in the two-way contingency table.

6. The method of claim 1, wherein the fixed marginal totals are row or column sums that are fixed by a user for a corresponding row or column in its respective margin of the two-way contingency table in response to the Multinomial sampling model.

7. The method of claim 1, wherein a first Bayes factor estimation method in the plurality of Bayes factor estimation methods is utilized to analyze a two by two contingency table to estimate the Bayes factor under the Poisson sampling model when a total number of frequency count observations is fixed and is less than or equal to a first defined threshold level of five hundred.

8. The method of claim 1, wherein a second Bayes factor estimation method in the plurality of Bayes factor estimation methods is utilized to analyze a two by two contingency table to estimate the Bayes factor under the Poisson sampling model when a total number of frequency count observations is greater than a first defined threshold level of five hundred.

9. The method of claim 1, wherein a third Bayes factor estimation method in the plurality of Bayes factor estimation methods is utilized to analyze a two by two contingency table to estimate an intermediate metric and the Bayes factor under the Multinomial sampling model when marginal row totals or marginal column totals are fixed and both totals are less than or equal to a second defined threshold level of five thousand.

10. The method of claim 1, wherein a fourth Bayes factor estimation method in the plurality of Bayes factor estimation methods is utilized to analyze a two by two contingency table to estimate an intermediate metric and the Bayes factor under the Multinomial sampling model when marginal row totals or marginal column totals are fixed and either or both totals are greater than a second defined threshold level of five thousand.

11. The method of claim 1, wherein a fifth Bayes factor estimation method in the plurality of Bayes factor estimation methods is utilized to analyze a contingency table larger than two by two to estimate the Bayes factor under the Poisson sampling model when a total number of frequency count observations is fixed.

12. The method of claim 1, wherein a sixth Bayes factor estimation method in the plurality of Bayes factor estimation methods is utilized to analyze a contingency table larger than two by two to estimate an intermediate metric and the Bayes factor under the Multinomial sampling model when marginal row totals or marginal column totals are fixed.

13. A computer system comprising:
a bus system;
a storage device connected to the bus system, wherein the storage device stores program instructions; and
a processor connected to the bus system, wherein the processor executes the program instructions to:
determine table dimensions of a two-way contingency table;
determine a statistical model type to apply to the two-way contingency table, wherein the statistical model type is selected from a group consisting of a Multinomial sampling model and a Poisson sampling model;
specify fixed marginal totals of the two-way contingency table for either rows or columns in response to the Multinomial sampling model being applied to the two-way contingency table;
compute a table total in response to the Poisson sampling model being applied or the fixed marginal totals in response to the Multinomial sampling model being applied when the two-way contingency table is two by two;
compare the table total to a first defined threshold level in response to the Poisson sampling model being applied or the fixed marginal totals to a second defined threshold level in response to the Multinomial sampling model being applied when the two-way contingency table is two by two;
select a Bayes factor estimation method from a plurality of Bayes factor estimation methods to apply to the two-way contingency table based on determined table dimensions of the two-way contingency table, sampling model applied to the two-way contingency table, and specified fixed marginal totals of the two-way contingency table; and
apply the selected Bayes factor estimation method to the two-way contingency table to estimate a Bayes factor that statistically infers independence of categorical variables in the two-way contingency table.

14. The computer system of claim 13, wherein the processor further executes the program instructions to:
receive the two-way contingency table from a client device of a user, the two-way contingency table containing a set of two categorical variables and each categorical variable in the set of two categorical variables includes a set of two or more frequency counts, wherein the table dimensions of the two-way contingency table are determined based on a number of categories corresponding to the set of two categorical variables.

15. The computer system of claim 14, wherein the processor further executes the program instructions to:
send the Bayes factor estimation method to the client device of the user.

16. The computer system of claim 13, wherein the processor further executes the program instructions to:
execute Bayes factor estimations for a plurality of different two-way contingency tables from a plurality of client devices at a same time in parallel to increase computing performance.

17. A computer program product comprising a computer readable storage medium having program instructions embodied therewith, the program instructions executable by a computer to cause the computer to perform a method comprising:
determining table dimensions of a two-way contingency table;
determining a statistical model type to apply to the two-way contingency table, wherein the statistical model type is selected from a group consisting of a Multinomial sampling model and a Poisson sampling model;
specifying fixed marginal totals of the two-way contingency table for either rows or columns in response to the Multinomial sampling model being applied to the two-way contingency table;
computing a table total in response to the Poisson sampling model being applied or the fixed marginal totals in response to the Multinomial sampling model being applied when the two-way contingency table is two by two;
comparing the table total to a first defined threshold level in response to the Poisson sampling model being applied or the fixed marginal totals to a second defined threshold level in response to the Multinomial sampling model being applied when the two-way contingency table is two by two;
selecting a Bayes factor estimation method from a plurality of Bayes factor estimation methods to apply to the two-way contingency table based on determined table dimensions of the two-way contingency table, sampling model applied to the two-way contingency table, and specified fixed marginal totals of the two-way contingency table; and
applying the selected Bayes factor estimation method to the two-way contingency table to estimate a Bayes factor that statistically infers independence of categorical variables in the two-way contingency table.

18. The computer program product of claim 17 further comprising:
receiving the two-way contingency table from a client device of a user, the two-way contingency table containing a set of two categorical variables and each categorical variable in the set of two categorical variables includes a set of two or more frequency counts, wherein the table dimensions of the two-way contingency table are determined based on a number of categories corresponding to the set of two categorical variables.

19. The computer program product of claim 18 further comprising:
sending the Bayes factor estimation method to the client device of the user.

20. The computer program product of claim 17 further comprising:
executing B ayes factor estimations for a plurality of different two-way contingency tables from a plurality of client devices at a same time in parallel to increase computing performance.
